(19) United States
(12) Patent Application Publication
(10) Pub. No.: US 2015/0024816 A1
(43) Pub. Date: Jan. 22, 2015

(54) GAME STRATEGY SYSTEM AND METHOD

(71) Applicants: J. Scott Ehrens, Las Vegas, NV (US); Michael Jones, Aurora, CO (US)

(72) Inventors: J. Scott Ehrens, Las Vegas, NV (US); Michael Jones, Aurora, CO (US)

(21) Appl. No.: 14/336,706

(22) Filed: Jul. 21, 2014

Related U.S. Application Data
(60) Provisional application No. 61/857,045, filed on Jul. 22, 2013.

(51) Int. Cl. A63F 13/85; A63F 13/25; A63F 13/40; G07F 17/32

(52) U.S. Cl. CPC A63F 13/85; G07F 17/3293; A63F 13/25; A63F 13/40
USPC 463/9

(57) ABSTRACT

A game strategy system provides game strategy in the form of recommendations to players. The system includes mobile device and application components used to capture images or other input containing game data. The game data is analyzed to general one or more recommendations for a particular game and particular set of game indicia, such as playing cards of a poker game. The system detects particular games and alters its recommendations based on the particular game being played. Location and other information may be part of the game data. In addition, one or more remote servers may be used to analyze, monetize, and publish game data, as well as to provide tournament awards to players.

### CROSS-REFERENCE TO RELATED APPLICATION

This application claims priority to U.S. Provisional Application No. 61/857,045, titled Methods and Systems for Providing Game Strategy, filed Jul. 22, 2013.

### BACKGROUND OF THE INVENTION

1. Field of the Invention

The field of the invention relates generally to methods and systems for providing game strategy, and more particularly to computer-implemented methods and systems for providing game strategy using machine vision with electronic games.

2. Related Art

Players of electronic games typically seek to win or at least do well at such games. Often players improve by practicing or repeatedly playing one or more games. Even though players may improve their game play and increase their rate or amount of winnings, a player may not be aware of how he or she can improve further. Further repetition typically does not resolve this issue.

Electronic games are widespread and provide much desired entertainment. However, if players do no continue to improve they may grow bored or stop playing a particular game believing that they have mastered the game to the best of their ability.

From the discussion that follows, it will become apparent that the present invention addresses the deficiencies associated with the prior art while providing numerous additional advantages and benefits not contemplated or possible with prior art constructions.

### SUMMARY OF THE INVENTION

A game strategy system and methods therefor are disclosed herein. The game strategy system aids players during play of particular games. This helps players determine and recognize a winning strategy for a particular game. In this manner, a player can experience increased success at various games. Over time, a player may, based on their ability and particular circumstances, be able to improve their own game play abilities by learning from the game strategy system.

Various implementations of a game strategy system are provided herein. For instance, in one exemplary embodiment a game strategy system may be implemented in a mobile device for providing game strategy comprising a camera, a GPS sensor, a storage device, a display, a processor, and machine readable code stored on the storage device and executable by the processor.

The machine readable code comprises an image recognition module that detects game data in one or more images captured by the camera, wherein the game data includes a plurality of game indicia, a game identifier module that identifies one of a predefined set of games from the game data, wherein the game data also includes location data generated by the GPS sensor, and a recommendation module that generates one or more recommendations based on the plurality of game indicia and the identified game from the predefined set of games. A presentation module that displays the one or more recommendations in human readable format on the display is also included.

A communication device for communicating with a remote server may also be provided. In such case, the machine readable code may retrieve additional game data from the remote server when the identified game is identified from the predefined set of games. In addition or alternatively, the machine readable code may transmit the plurality of game data to the remote server via the communication device.

The game strategy system may provide recommendations for a variety of games. For example, in a poker game, the plurality of game indicia are each playing cards of a poker game. The game indicia may also be playing cards in a blackjack game. In general, the one or more recommendations will indicate a subset of the plurality of game indicia to hold. Also, the display may present one or more indicators to align the camera when the camera is capturing the one or more images.

In another exemplary embodiment, the game strategy system may be a mobile software application for providing game strategy fixed on a tangible storage medium comprising a game data source module that receives data from an input device or sensor and detects game data within the data, wherein the game data comprises a plurality of game indicia, a game identifier module that identifies a game from a predefined set of games based on a subset of the game data, and a recommendation module that generates one or more recommendations based on all of the game data, wherein the one or more recommendations identify a subset of the plurality of game indicia to hold during game play. A presentation module that formats the one or more recommendations in human readable format for presentation on a display is also included. Each of the modules of the mobile software application comprise one or more instructions that are executable on a processor.

The game data source module may include an image recognition module to detect game data from data comprising one or more images. Alternatively or in addition, the game data source module includes a user input module to detect game data from data comprising manual input from a user. The game data includes a game name and/or location information and the game data source module communicates with a GPS sensor to obtain the location information. The recommendation module may compare the plurality of game indicia to a ranking of potentially winning outcomes to generate the one or more recommendations.

In another exemplary embodiment, a mobile device implemented method for providing game strategy is provided, with such method comprising capturing one or more images of a game with a camera of the mobile device, detecting game data within the one or more images with a processor of the mobile device, and identifying a particular game based on all of the game data. The game data includes a plurality of game indicia.

This method also includes comparing the plurality of game indicia to a ranking of potential winning outcomes, generating one or more recommendations identifying a subset of the plurality of game indicia to hold based on the comparison, and presenting the one or more recommendations on a display of the mobile device.

Location information may be generated with a GPS sensor of the mobile device, and included in the game data and used in identifying the particular game. It is noted that at least some of the game data may be received from a user via a user input device. The display may present one or more indicators to align the camera when the one or more images are captured. The plurality of game indicia may be transmitted to a remote server for online publication.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a block diagram illustrating an exemplary mobile device.

FIG. 2 is a block diagram illustrating an exemplary mobile application.

FIG. 3 is a flow diagram illustrating operation of an exemplary mobile application.

FIG. 4 illustrates an exemplary image capture screen including indicators.

FIG. 5 illustrates an exemplary image capture screen including indicators.

FIG. 6 illustrates an exemplary game selection screen.

FIG. 7 illustrates an exemplary recommendations generated by the game strategy system.

FIG. 8 illustrates an exemplary recommendations generated by the game strategy system.

FIG. 9 is a flow diagram illustrating operation of a boast feature.

FIG. 10 is a flow diagram illustrating operation of rules application to produce one or more recommendations.

FIG. 11 illustrates an exemplary deals screen.

FIG. 12 illustrates an exemplary menu screen.

### DETAILED DESCRIPTION OF THE PREFERRED EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

The game strategy system herein represents a technological step forward in playing electronic games. Players or other users of the game strategy system desire a sense of mastery while they are playing. Beginning players feel less like “fish”—inexperienced, losing players—because the game strategy system acts as a guide. Advanced players know they are making the right move when facing complex decisions where major potential winnings are on the line because the game strategy system provides statistical analysis. Video poker is used herein as an example, but the game strategy system can be used with any video-based game that includes any strategic decision point for the player—Deal Or No Deal, Video Blackjack, and non-wagering games, etc. All players are provided this sense of mastery without changing the odds of the game—which is advantageous for game machine providers and casinos.

Moreover, the game strategy system includes the ability to offer casino operators and other relevant advertisers the opportunity to reach live on-premises players with relevant promotions and bonuses to increase their play, entice them to other revenue generating opportunities (spa, restaurants, competing casinos) and expand their loyalty to casino properties (see FIG. 11). It may be a wireless players card with real-time second screen opportunities for advertising, promotions, play-related bonuses, and even meta-games, progressives and tournaments that can further add a social and even global element to existing land-based gaming. Players desire this because it enriches their play and it gives them bonuses that matter to them.

In one exemplary embodiment, the game strategy system is implemented via a mobile application executable on a mobile device, such as a cell phone. The mobile application comprises a plurality of instructions configured to provide the game strategy system functionality disclosed herein. At least some of the instructions will be used to calculate game strategy. The mobile application will typically also include one or more hardcoded or predefined values, such as predefined tables or records for determining game strategies.

The mobile application may be hardwired into a processor 108 of the mobile device 104. Alternatively, the mobile application may be retrieved for execution at a processor 108 from a storage device 120. The mobile application could also be downloaded from a remote source, such as a remote server 132. A wired or wireless communication device 116 may be used to communicate with remote servers 132 or other external devices. It is noted that a processor 108 may be a microprocessor, microcontroller, or various other electronic circuits arranged to provide the functionality disclosed herein.

A memory device 112, such as RAM, may be provided to provide temporary storage for use by a processor 108, while a storage device 120 provides more permanent or nonvolatile storage. For example, a storage device 120 may utilize magnetic, optical, or flash memory based storage technology. In operation, a memory device 112 may store various variables used during calculations performed by the mobile application. It is contemplated that one or more instructions that make up the mobile application may be cached in the memory device 112 as well.

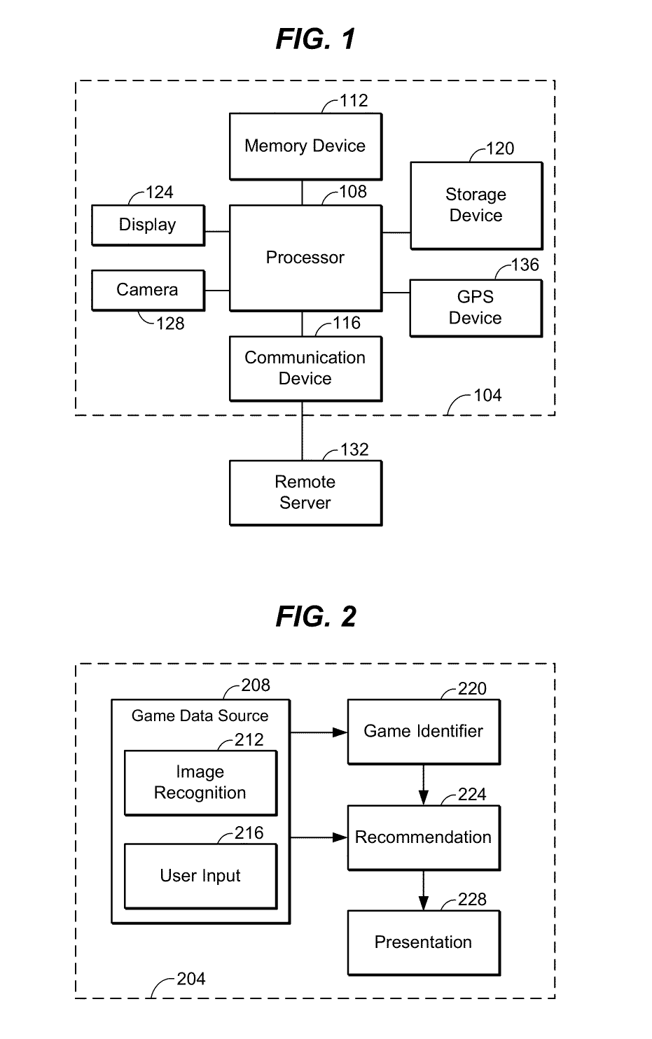

As can be seen from FIG. 1, the mobile device 104 also includes a camera 128 or similar sensor that enables the mobile device 104 to capture one or more images of a game. Via such camera 128, the mobile device 104 may take a picture or video of the display of a video poker machine. Visual elements can then be analyzed for game data by the mobile device 104, such as by a processor 108 of the mobile device.

It is noted that the mobile device 104 may perform such analysis, such as via its processor 108, or it may send images to a remote server 132 for processing and receive the game data from the remote server via a communication device 116. The game data may include game name, game type or variation, game layout, game piece information (e.g., card suit and value), paytable, buttons, etc.

For example, an image of a video poker screen may be captured and the game data therein may include the name of the game such as “Aces Revenge”, the game type such as “Deuces Wild”, the position of the cards, which cards are showing, the face of each shown card, and the buttons that are available such as “Hold.” The mobile device 104 may determine game data based on other data as well. For example, the mobile device 104 may determine the game name based on the location of the cards or other elements.

Game data may also include location data, such as geographic coordinates, and gaming establishment or other property identifiers. In one or more embodiments, the mobile device 104 will include a GPS device 136 for determining the location of the player. This is advantageous in that particular games may be played according to different rules at different gaming establishments. In other words, games may be different based on where the player is playing. Using location data, the game strategy system can better determine what game is being played, what rules to apply when generating recommendations, or both.

An exemplary mobile application 204 implementing the game strategy system will now be described with respect to FIG. 2. As can be seen, a mobile application 204 may comprise various modules. The modules themselves may comprise one or more groupings of instructions.

As shown in FIG. 2, the mobile application 204 comprises a game data source 208, game identifier module 220, recommendation module 224 and presentation module 228. In general, the game data source 208 receives game data, detects game data or both. For instance, as shown the game data source 208 has an image recognition module 212 for recognizing or detecting game data, and a user input module 216 for receiving game data inputted by a player. The image recognition module 212 will typically receive one or more images from a camera or other sensor/source and analyze the images to detect game data within the images. The user input module 216 will typically receive game data directly from a player. For instance, a player may manually input card and other information for a game.

Game data may be used at a game identifier module 220. Typically the game identifier module 220 will determine or detect what game is being played based on the game data. For example, the game identifier module 220 may determine a game by its name, paytable or other characteristics. Once a game is identified, this information (i.e., a game identifier) may be used at a recommendation module 224 along with other game data. In general, the recommendation module 224 will generate one or more recommendations, such as one or more suggested strategies or moves, for the player, as will be described further below.

A recommendation can then be presented by a presentation module 228. In one or more embodiments, the presentation module 228 may format the strategy or move so that it can be presented visually, audibly or in other ways to a player. For instance, a presentation module 228 may add text providing instructions to a player on how to proceed with his or her game play, as will be described further below as well.

It is noted that various of the modules may be executed at various locations including locations that are remote from one another, such as described briefly above. For example, a game data source 208 may be executed on a mobile device with a camera, while a game identifier module 220, recommendation module 224 or both are executed on a remote server or other remote device. Communication devices would communicate the necessary information between the modules, such as game data, suggested strategies or moves and other information. Individual modules may reside on tangible storage media locally or remotely accessible to the mobile device, server or other device executing the module.

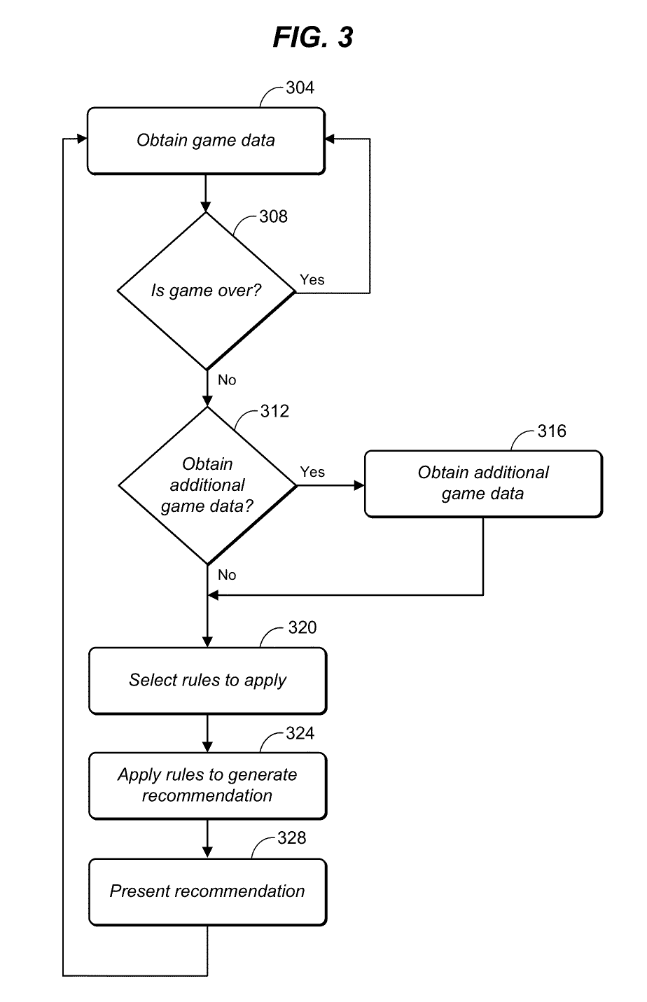

Operation of game strategy system will now be described with regard to FIG. 3. FIG. 3 is a flow diagram illustrating operation of an exemplary game strategy system that may be executed on a mobile or other device. At a step 304 game data is received, detected or both, such through analysis of one or more images captured by a camera or via manual entry from a player, such as via one or more input buttons or other input devices of a mobile device. If location data is desired, the same may be determined, such as via a GPS sensor or device, and included in the game data at step 304. It is noted that, similar to other game data, a player may manually enter location data, such as by specifying the gaming establishment where the player is playing.

At a decision step 308, the game data may be used to determine if the game has ended or is in a “game over” state. For instance, if the game data indicates a final outcome has occurred or the game is presenting a game over condition, the game is determined to be over. The process may then continue back at step 304 where game data for a new game may be obtained.

If the game is not over at decision step 308, it may be determined whether to retrieve additional game data at a decision step 312. For example, the mobile device may access a database of known games to retrieve additional game data about a particular game at a step 316. Such database may include the number of decks used in a particular game or other game variations like what the winning hands are for the particular game. The database may be stored on a remote server, locally on a storage device, or both. In general, the additional game data will be retrieved if helpful to making a recommendation to the player.

At a step 320, one or more instructions or rules to use in providing a recommendation are selected. The rules may be embodied in a strategy or collection of rules. In some embodiments, a mobile application may include one or more strategies and may download additional strategies from a remote server. The rules will typically be selected based on the game data, such as which game is being played and which cards are shown.

Using game data captured from the game itself and any additional game data from the database, the one or more selected rules may be applied at a step 324 to generate one or more recommendations. The one or more recommendations may be presented together with a predicted chance of success based on the game data and statistical analysis at a step 328. Presentation may occur on a screen or display. A recommendation may include a move or moves to be made, such as which cards to hold in a video poker game. It is noted that the display may also be used to aid a player in capturing a game data, such as at step 304, by showing what is or will be captured by the mobile device's camera.

After the one or more recommendations are presented, the player may make a move. After making a move, whether it was a recommended move or not, game data maybe obtained again such as by capturing one or more images of the game screen again at step 304. In these subsequent screen image captures, the results of a previous move may be analyzed. It is contemplated that the player may input the played move, indicate which recommendation was followed, or the mobile application may detect the moved played based on the differences between the previous screen and the current screen.

Depending on the game, the mobile application may continue to capture the screen, provide recommendations, and/or record the outcome of game plays. The mobile application may use game play results to alter the statistical analysis. For example, the mobile application may use discarded cards from previous moves to refine the likelihood of certain cards being dealt in the future. Game play results may be transmitted to a remote server for aggregation and further analysis or may be analyzed locally at a mobile device's processor. The aggregated results may be used to improve analysis of certain games or even certain games at certain casinos.

Upon occurrence of a winning outcome, the mobile application may be used capture the screen and detect the winning outcome, including any payouts. The play that led to the outcome and the outcome itself may be reported to the remote server for similar further analysis. In some embodiments, the player may boast about a win using social media via the mobile application. Other users of social media or the mobile application may be able to see boasted or reported winnings of other players. In some embodiments, the remote server may provide a heat map of which games, casinos, and/or gaming machines are producing favorable results. The heat map may be shown in the mobile application as an actual map or as an ordered listing of favorable results. For example, a player at the mobile application may be able to see that a particular video poker game at a particular casino is “hot” and so can go play that game.

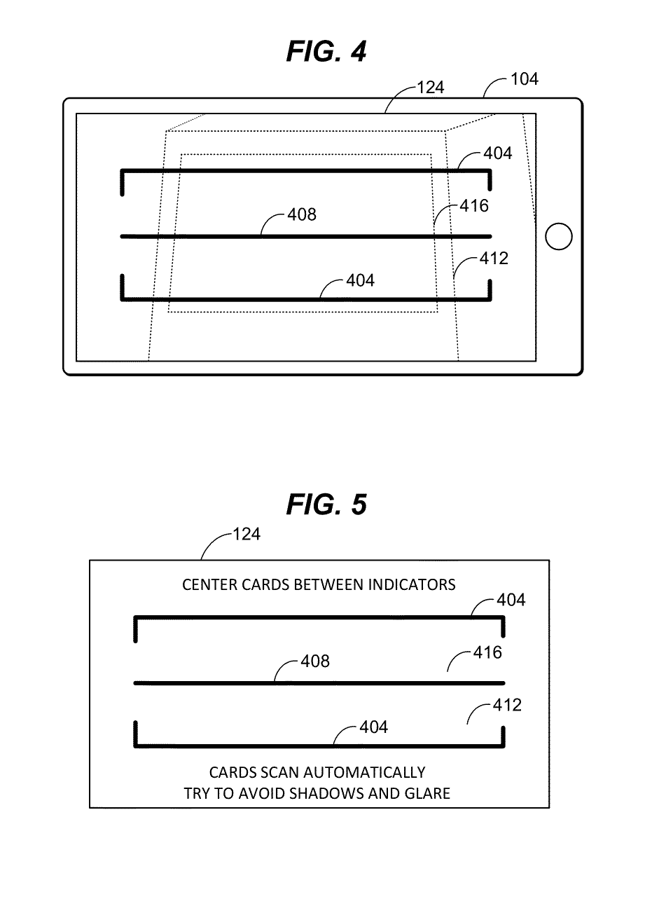

The mobile application may be programmed to selectably capture images, giving the player an option to capture the image, if at all, or manually input game data. Image capture may be accomplished using traditional camera controls such as a button to take the picture. A guide including one or more indicator marks 404, 408, such as that shown in FIG. 4, may be overlaid or made available when capturing an image to assist the player in getting more accurate results. In the example of FIG. 4, the indicator marks 404, 408 assist the player in correctly orienting the mobile device 104 to capture an image of a screen 416 of a gaming machine 412. As shown in FIG. 5, the player may be directed via onscreen prompts or instructions to position the camera such that cards or other game indicia are aligned with one or more indicator marks 404, 408 to help ensure a usable image is captured.

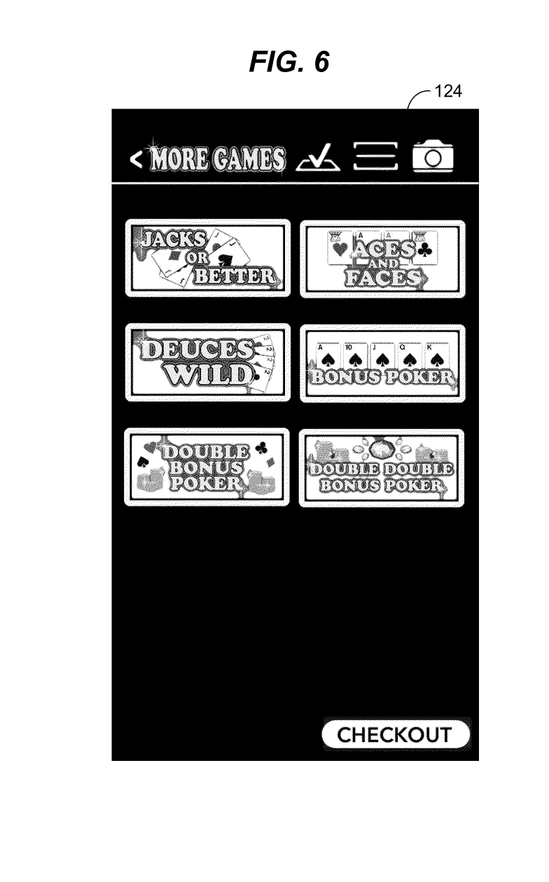

During operation, the mobile application may provide other functionality. For example, the mobile application may (1) present a splash screen, that includes the brand, and possibly some copy; (2) present a game selection screen prompting the player to select a game, such as shown in FIG. 6; (3) present a location identification or selection screen prompting the player to activate a GPS sensor to identify their location or to manually enter their location (e.g. Aria Las Vegas or Cosmo Las Vegas); (4) present an image capture screen, such as shown in FIGS. 4-5, with a static or animated overlay (that may include one or more indicator marks 404, 408) to instruct the player on how to capture images using a camera; and (5) hide the image capture screen with or without an animated fade or other effect and thereafter deactivate the image capture function.

During image capture the player may be instructed to hold a camera viewfinder of the capture screen so that cards dealt, bet size (units), and wager amount is captured. As disclosed above, upon capture, the image data may be relayed to one or more analytic software modules executed locally, at a remote server, or both for detection of game data determination of optimal move (e.g., recommendation(s) for which cards to keep and why).

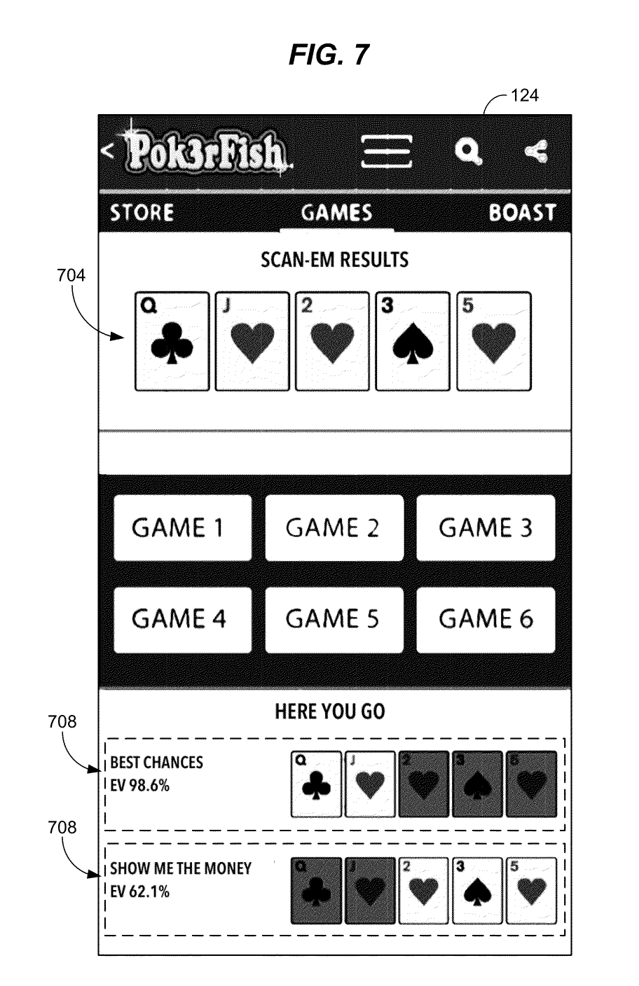

During presentation of one or more recommendations, cards 704 detected in an image may be presented on a display 124 as animated or static cards, such as shown in FIG. 7. Three (or four) buttons may appear with recommendations 708. As can be seen, a recommendation 708 may be presented in various ways. As shown for example, the recommendation 708 includes a suggested move (i.e., which cards to hold and discard) along with a label indicating the strategy for the recommendation. To illustrate, in FIG. 7 a “BEST CHANCES” recommendation 708 which represents the players best chance of winning is presented, along with a “SHOW ME THE MONEY” recommendation which represents a strategy to maximize winnings while perhaps lowering the likelihood of any winning outcome.

A recommendation 708 may include various copy, such as “BEST MOVE” or “LOW ODDS BUT HUGE PAYOUT” OR “SHOW ME THE MONEY” or “I'M FEELING LUCKY,” as well as associated odds and payouts. It is contemplated that each recommendation 708 may be interactive. As shown in FIG. 7 for example, if a player selects or engages one of the recommendation, such as by tapping or touching it, certain cards in the recommendation 708 may be grayed out or highlighted, reflecting whether to keep or throw them away.

It is noted that recommendations may be presented in various other ways. For instance, FIG. 8 illustrates exemplary recommendations 708 and presentation thereof on a display 124. In this embodiment, a player may select different games via a game selector control 712. As can be seen, for the same cards 704, a recommendation 708 may change based on the selected game (i.e., the game being played).

After one or more recommendations 708 are presented, it may be presumed in some embodiments that the player then makes their move at the video poker or other gaming machine. The player may be prompted to press a button that says “CONTINUE TO NEXT HAND” or the like to indicate the player has made their move. This may cause the mobile application to activate image capture for example. Alternatively or in addition, the player may be provided one or more buttons to “SCAN RESULTS”, “BOAST ON FACEBOOK”, and “EARN BONUSES.”

A “BOAST TO FACEBOOK” option allows the player to scan their game play outcome for transmission to a remote server or service. This feature may be used to provide participation in a tournament that pits players using the game strategy system from many different physical locations against one another. To illustrate, one exemplary tournament might be a “BEST HAND IN VEGAS” tournament run daily where the best hand captured/detected by the game strategy system, such as via manual entry or image analysis, wins an award.

A tournament will typically be supported by a remote server which receives the game play outcomes of various players for comparison purposes to determine one or more winners of the tournament. The remote server can then award one or more winners their winning such as by initiating a monetary or points transfer or transmission or shipment of a prize to the one or more winners. Contact, account, and/or address information may be collected from player via the mobile application and transmitted to the remote server.

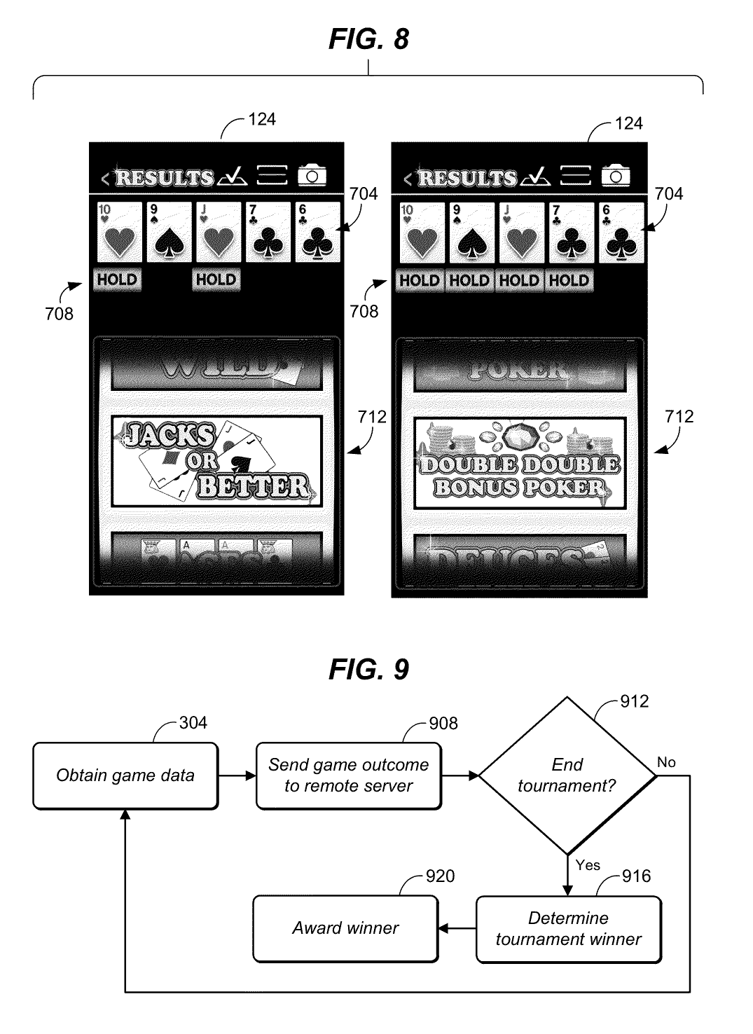

FIG. 9 illustrates an exemplary process by which a tournament may be conducted with outcomes scanned/captured by multiple players via a mobile application. Game data may be obtained at a step 304, such as described above. Though not illustrated, it is noted that additional game data may also be obtained as described above. At a step 908, the game outcome in the game data is transmitted to a remote server, where it may be stored. It is noted that the remote server may publish or post game outcomes publicly once received, such as via an online listing. At a decision step 912, it is decided whether or not to end the tournament. This may occur based on various criteria. For example, a daily tournament may be ended at the end of each calendar day. If the tournament has not ended, additional game outcomes may be received via steps 304 and 908 from various players.

If the tournament has ended, a tournament winner may be determined at a step 916. In general, a tournament winner is a player having an outcome (i.e., poker hand) that is better than at least some but typically all other outcomes received at the remote server. The remote server may apply its own ranking scheme to rank the hands of one or more players. Multiple players may be winners as well. At a step 920 the winning player may be awarded a predefined prize, payout or other award.

It is contemplated that in some implementations:

1) The mobile application uses scanaltyics (i.e., image capture and analytics) to be extensible to other products (e.g. scanning math formulae to be solved or to trigger tutorials, etc.);

2) The location of every hand scanned in may be captured (e.g., with GPS or Wi-Fi methods), and the data is stored and analyzed for advertisers (player name, location, game played, $ per push, $ per hour, # of hours played, etc. are just some of the metrics that can be analyzed and monetized);

3) In-game advertising and promotions in various formats may be offered;

4) A “home screen” (such as in the form of a slide-over page) which includes user profile information and a history of hands played (including the hands the player has scanned or boasted about) may be provided; and

5) Generated heat maps of “hot machines” based on the big hands boasted to Facebook (or other social media) by players may be provided.

Heat maps of “hot machines” may be implemented with cooperation from the gaming establishments. For example, games may be configured to provide in-game QR codes that identify a game or machine and/or location thereof. Alternatively or in addition, a mobile device's GPS sensor, some sort of player input, or both (e.g. Machine #104 at Aria Hotel Casino) may be used to identify machines for inclusion in a heat map.

In some embodiments, the following are observed. Using rules from wizardofodds.com, such as those listed below which are incorporated herein by reference, analyze each hand for a given game based on the rules from the site.

Jacks or better simple strategy: http://wizardofodds.com/games/video-poker/strategy/jacks-or-better/9-6/simple/

Full-Pay deuces wild simple strategy: http://wizardofodds.com/games/video-poker/strategy/deuces-wild/full-pay/simple/

8/5 bonus poker basic strategy: http://wizardofodds.com/games/video-poker/strategy/bonus-poker/8-5/

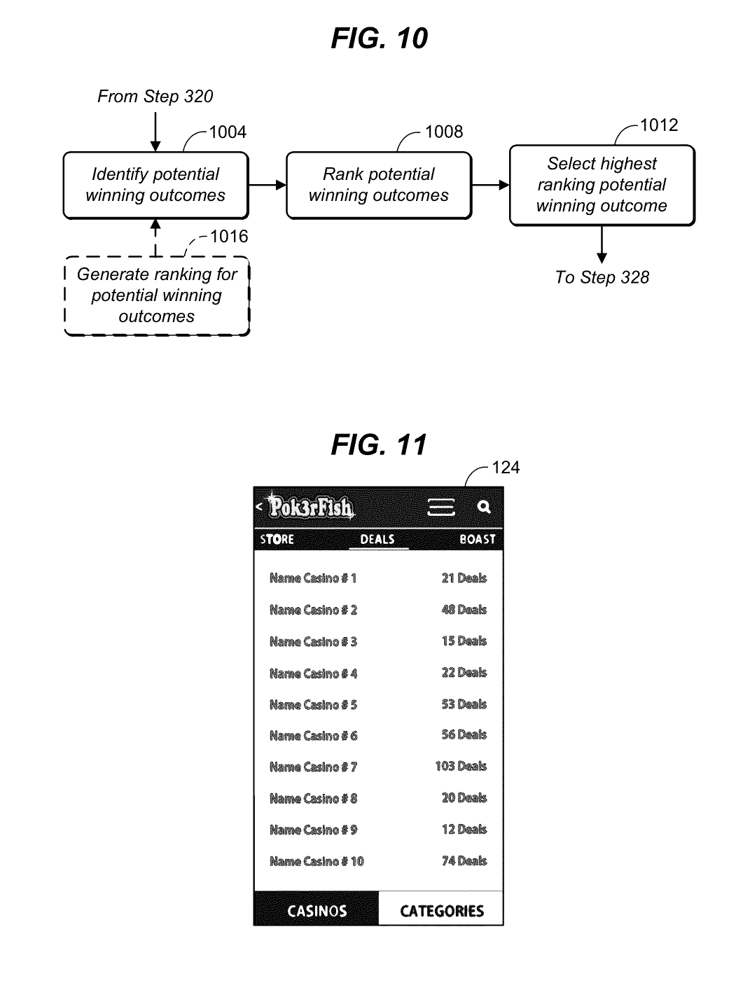

FIG. 10 illustrates application of rules by an exemplary game strategy system. Such application may be implemented in the mobile application or at a remote server, such as described above. As alluded to in FIG. 10, it is noted that this application may occur at step 324 of FIG. 3.

At a step 1004, potential winning outcomes from cards or other game indicia currently dealt or assigned to the player may be determined. This may occur by evaluating the player's cards to determine the outcomes that can arise from these cards and identifying any winning outcomes therein. At a step 1008, the potential winning outcomes may be ranked according to a predefined ranking or list. At a step 1012, the highest ranking potential winning outcome may be selected. The resulting recommendation may be presented at step 328. In this example, the recommendation comprises a suggestion, indication or instruction to hold cards that will allow the potential winning outcome to occur, while discarding the other cards.

As can be seen, an optional step 1016 may be included as well. The ranking or ordered list by which potential winning outcomes are ranked may be generated at step 1016. Typically, the ranking will be stored on a mobile device or remote server. In addition, a mobile application may retrieve the ranking for a mobile device from a remote server. One exemplary ranking from wizardofodds.com comprises:

| Rank | Potential Winning Outcome |
|---|---|
| 1 | Four of a kind, straight flush, royal flush |
| 2 | 4 to a royal flush |
| 3 | Three of a kind, straight, flush, full house |
| 4 | 4 to a straight flush |
| 5 | Two pair |
| 6 | High pair |
| 7 | 3 to a royal flush |
| 8 | 4 to a flush |
| 9 | Low pair |
| 10 | 4 to an outside straight |
| 11 | 2 suited high cards |
| 12 | 3 to a straight flush |
| 13 | 2 unsuited high cards (if more than 2 then |
| | pick the lowest 2) |
| 14 | Suited 10/J, 10/Q, or 10/K |
| 15 | One high card |
| 16 | Discard everything |

As stated, recommendations will typically be generated by taking a given hand (from a captured image or manual player input) and analyze it for rules of a given game, in a two part or two step manner comprising: (1) hand analysis; and (2) game rules.

Hand Analysis:

This includes taking a given hand and looking for common aspects of poker hands such as:
Multiple of the same value (e.g., a pair of sevens)
Multiple of the same suite (e.g., four hearts)
Ordered values (e.g., 2, 3, 4 or 10, J, Q, K)
High cards (versus low cards)—10 or better

Game Rules:

Each game has its own set of rules (see above) to match against the hands.

For each set of rules, the top rule is best and each are incrementally “worse”. This means we try to match the best one and stop when we reach the first one matched.

For ‘jacks or better simple’ the first 3 rules are:

1. Four of a kind, straight flush, royal flush

2. 4 to a royal flush

3. Three of a kind, straight, flush, full house

Based on the Hand Analysis, the mobile application will determine if the cards contain a multiple of four, five ordered cards, and five same suited cards, five ordered cards (lowest a ten), and five same suited cards.

If not, it will check to see if the hand has four ordered cards starting at ten or Jack and those same cards of same suit. In this case, the multiple of four same suited cards from the Hand Analysis may not apply since we need them to also be the ordered cards.

If that's also not a match, it will check to see if the Hand Analysis has a multiple of three, five ordered cards, five suited cards or a multiple of two and a multiple of three.

If not it will continue on to the other rules until there's a match.

Given that each game's rules are different, but there is commonality, the Hand Analysis can help rule out matches quickly. However, the specific rule will need to be unique. Another abstraction can be that there is a single method that takes a Hand Analysis and returns if it matches a given state like “four of a kind” or “full house.” Then rules like Rule 3 above can be a series of four calls to four methods for 3 of a kind, straight, flush and full house.

This way another game may have a rule that uses some subset of those four cases.

Further, the hand may be something like 4 of hearts, 5 of spades, 6 of hearts, 7 of diamonds and 4 of diamonds. However the Hand Analysis may reorder the cards in ascending order with a certain order to the suits. Part of the data will maintain the original order so that a given method (e.g., 3 of a kind) may return the cards that make up that hand. From there, the app can determine which cards to hold and which to discard.

The UI would be updated with these outputs for hold/discard.

The intention of the Hand Analysis and Game Rules is to develop the logic such that it is reusable and scalable but not over engineered in writing a “poker artificial intelligence” engine.

In some embodiments, the subject matter is implemented as part of a gaming machine. The tasks of image recognition may take place as images as captured directly from the video hardware of the gaming machine, however, it would be preferable to capture the game data directly from the computing hardware of the gaming machine. For example, an additional module (whether software and/or hardware, etc.), may be added to the gaming machine to receive gaming data and cause strategy hints and other data to be displayed on the gaming machine, its main display, a secondary display, or on a mobile device associated with the player. Thus, the subject matter described herein may be embedded within the gaming machine to provide the same helpful tips and game analysis. The player may likewise interact with the subject matter by using inputs at the gaming machine. The steps of analysis and data interpretation may occur at the gaming machine or at a remote server. As with the mobile application implementation, the gaming machine may report on winning hands and other game data to be collected from other gaming machines, mobile applications, etc.

FIG. 11 illustrates an exemplary deals screen of the mobile application. It is contemplated that participating gaming or other establishments may share their promotions with player via the mobile application, such as by uploading their promotions to a remote server where the mobile application can retrieve such promotions. Promotions offered to a player may be based on location or other information from game data generated by the player's activities. Promotions may be displayed by the establishment offering them, by category (e.g., food, drink, entertainment), or in various other ways.

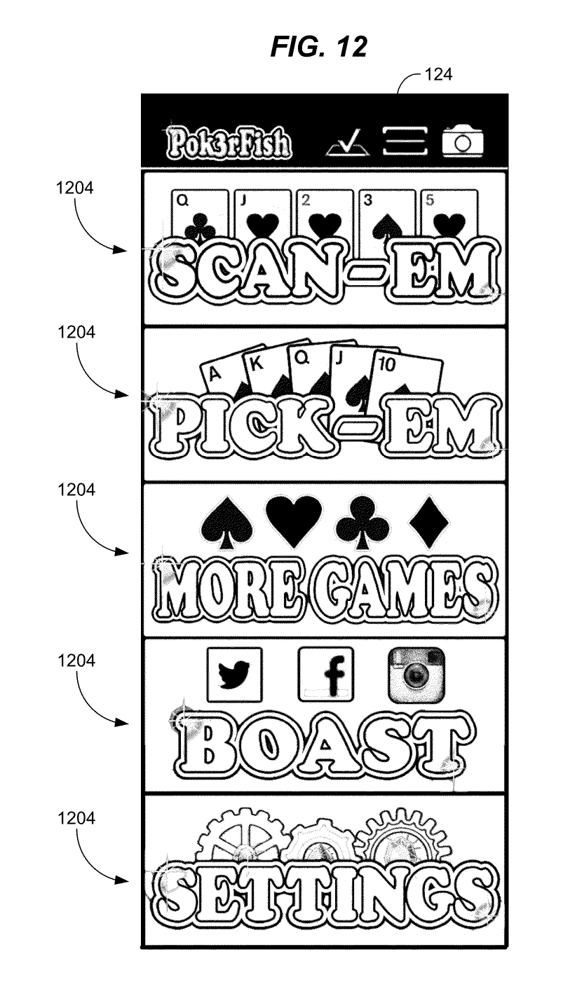

FIG. 12 illustrates an exemplary user interface screen comprising a plurality of buttons 1204 which a player may select to access a corresponding function of the mobile application, as described above.

Though describe above mainly with regard to various poker games, it is contemplated that the game strategy system may be used with a variety of games. For example, the game strategy system may be used with other card games, such as blackjack, or other wagering games in general. In a blackjack embodiment, the game strategy system may provide recommendations as to whether to hit, stand, split or the like based on the player's cards and the dealer's cards as scanned by a player's mobile application or device.

The logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It will be appreciated that the above embodiments that have been described in particular detail are merely example or possible embodiments, and that there are many other combinations, additions, or alternatives that may be included.

Also, the particular naming of the components (including, among other things, engines, layers, and applications), capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations may be used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as processing or computing or calculating or determining or identifying or displaying or providing or the like, refer to the action and processes of a computer system, or similar electronic computing device, that manipulates and transforms data represented as physical (electronic) quantities within the computer system memories or registers or other such information storage, transmission or display devices.

Based on the foregoing specification, the above-discussed embodiments of the invention may be implemented using computer programming or engineering techniques including computer software, firmware, hardware or any combination or subset thereof. Any such resulting program, having computer-readable and/or computer-executable instructions, may be embodied or provided within one or more computer-readable media, thereby making a computer program product, i.e., an article of manufacture, according to the discussed embodiments of the invention. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network. One or more processors may be programmed or configured to execute any of the computer-executable instructions described herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

1. A mobile device for providing game strategy comprising:
a camera;
a GPS sensor;
a storage device;
a display;
a processor; and
machine readable code stored on the storage device and executable by the processor comprising:
an image recognition module that detects game data in one or more images captured by the camera, wherein the game data includes a plurality of game indicia;
a game identifier module that identifies one of a predefined set of games from the game data, wherein the game data also includes location data generated by the GPS sensor;
a recommendation module that generates one or more recommendations based on the plurality of game indicia and the identified game from the predefined set of games; and
a presentation module that displays the one or more recommendations in human readable format on the display.

2. The mobile device for providing game strategy of claim 1 further comprising a communication device for communicating with a remote server.

3. The mobile device for providing game strategy of claim 2, wherein the machine readable code retrieves additional game data from the remote server when the identified game is identified from the predefined set of games.

4. The mobile device for providing game strategy of claim 2, wherein the machine readable code transmits the plurality of game data to the remote server via the communication device.

5. The mobile device for providing game strategy of claim 1, wherein the plurality of game indicia are each playing cards of a poker game.

6. The mobile device for providing game strategy of claim 1, wherein the one or more recommendations indicate a subset of the plurality of game indicia to hold.

7. The mobile device for providing game strategy of claim 1, wherein the display presents one or more indicators to align the camera when the camera is capturing the one or more images.

8. A mobile software application for providing game strategy fixed on a tangible storage medium comprising:
a game data source module that receives data from an input device or sensor and detects game data within the data, wherein the game data comprises a plurality of game indicia;
a game identifier module that identifies a game from a predefined set of games based on a subset of the game data;
a recommendation module that generates one or more recommendations based on all of the game data, wherein the one or more recommendations identify a subset of the plurality of game indicia to hold during game play; and
a presentation module that formats the one or more recommendations in human readable format for presentation on a display;
wherein each of the modules of the mobile software application comprise one or more instructions that are executable on a processor.

9. The mobile software application for providing game strategy of claim 8, wherein the game data source module includes an image recognition module to detect game data from data comprising one or more images.

10. The mobile software application for providing game strategy of claim 8, wherein the game data source module includes a user input module to detect game data from data comprising manual input from a user.

11. The mobile software application for providing game strategy of claim 8, wherein the game data includes a game name.

12. The mobile software application for providing game strategy of claim 8, wherein the game data includes location information and the game data source module communicates with a GPS sensor to obtain the location information.

13. The mobile software application for providing game strategy of claim 8, wherein the recommendation module compares the plurality of game indicia to a ranking of potentially winning outcomes to generate the one or more recommendations.

14. The mobile software application for providing game strategy of claim 8, wherein the plurality of game indicia are playing cards of a poker game.

15. A mobile device implemented method for providing game strategy comprising:
capturing one or more images of a game with a camera of the mobile device;
detecting game data within the one or more images with a processor of the mobile device, wherein the game data includes a plurality of game indicia;
identifying a particular game based on all of the game data;
comparing the plurality of game indicia to a ranking of potential winning outcomes;
generating one or more recommendations identifying a subset of the plurality of game indicia to hold based on the comparison;
presenting the one or more recommendations on a display of the mobile device.

16. The mobile device implemented method for providing game strategy of claim 15 further comprising generating location information with a GPS sensor of the mobile device, wherein the location information is included in the game data and used in identifying the particular game.

17. The mobile device implemented method for providing game strategy of claim 15 further comprising receiving at least some of the game data from a user via a user input device.

18. The mobile device implemented method for providing game strategy of claim 15, wherein the display presents one or more indicators to align the camera when the one or more images are captured.

19. The mobile device implemented method for providing game strategy of claim 15 further comprising transmitting the plurality of game indicia to a remote server for online publication.

20. The mobile device implemented method for providing game strategy of claim 15, wherein the plurality of game indicia are each playing cards of a poker game.
